(19) United States
(12) Patent Application Publication
(10) Pub. No.: US 2013/0068910 A1
(43) Pub. Date: Mar. 21, 2013

(54) Technical field and industrial applicability of the invention

(71) Applicant: David Nicholas Lloyd Howell, Malvern (GB)

(72) Inventor: David Nicholas Lloyd Howell, Malvern (GB)

(21) Appl. No.: 13/234,172

(22) Filed: Sep. 16, 2011

(51) Int. Cl. F16M 13/02; B60P 7/08; B65D 63/00; B63B 21/20

(52) U.S. Cl. 248/317

(57) ABSTRACT

A device that can be used to moor, tether or suspend an article has a spool mounted in a support frame. A flange of the spool may have holes or cleats so that a free end of a tape, rope, webbing, strap or the like wound on to a hub of the spool can be attached to the flange preferably by a clipping mechanism such as a carabiner attached to the free end thereby preventing the spool from rotating further. In this way the length of tape withdrawn from the spool remains fixed. Alternatively the end of the tape may be passed via a hole or cleat or the like and tensioned before being tied off.

### TECHNICAL FIELD AND INDUSTRIAL APPLICABILITY OF THE INVENTION

The present invention relates to a device for providing a fixed length of webbing, tape, rope or strapping for use in mooring, suspending or anchoring an article. The device has many applications ranging from the tethering of aircraft to the suspension of an article.

### BACKGROUND AND SUMMARY OF THE INVENTION

The securing device of the invention can be operated quickly and efficiently to moor or suspend an article. The device has a spool having a hub and a flange secured to an end face of the hub, a support frame comprising a spindle that passes through the hub in order to allow the spool to rotate relative to the support frame; a tape having one end fixed to the hub and a free end; means for enabling a free end of the tape to be secured to the flange at a periphery thereof; and means on the support frame for securing the device to an object.

The securing means can be a hole in the flange so that a clipping mechanism such as a karabiner attached to a free end of the tape can be clipped back to the flange thereby preventing the spool from rotating further. In this way the length of tape withdrawn from the spool remains fixed. The simplest variant of the device could simply have a series of holes in the flange to allow the free end of the tape to be tied off to the flange with a knot to secure the free end to the spool. Other securing means such as cleats mounted around the flange could be employed.

### DESCRIPTION OF THE ILLUSTRATIVE EMBODIMENTS

In order that the invention may be well understood two embodiments thereof will now be described, by way of example only, with reference to the accompanying diagrammatic drawings, in which:

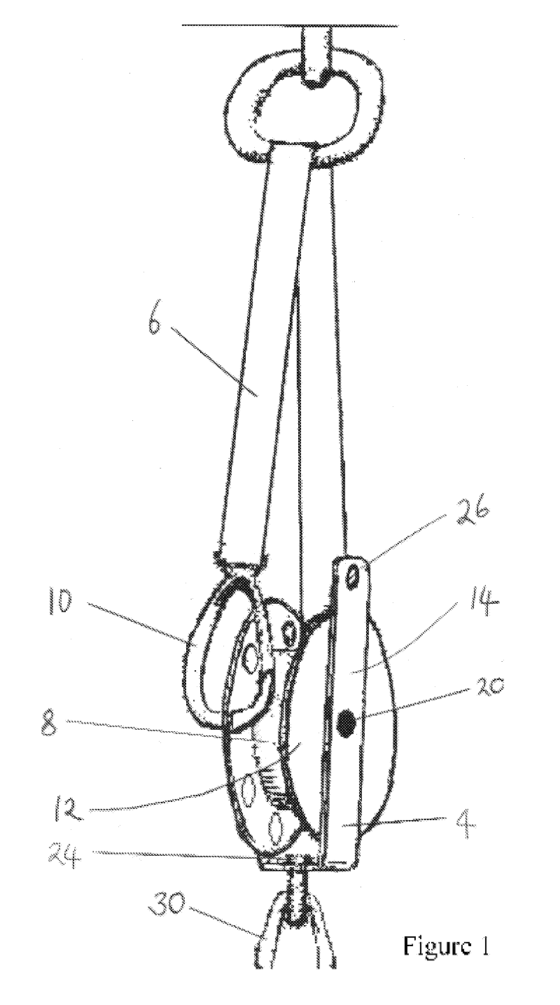

FIG. 1 represents a perspective view of a first embodiment of the device in use;

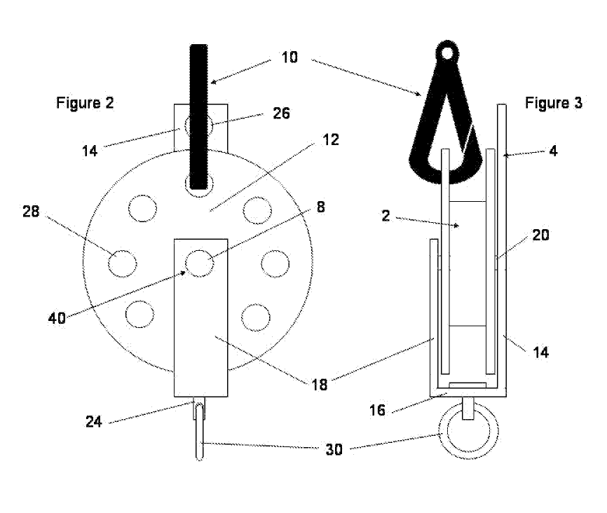

FIG. 2 shows a front view of the device of FIG. 1;

FIG. 3 shows a side view of the device of FIG. 1;

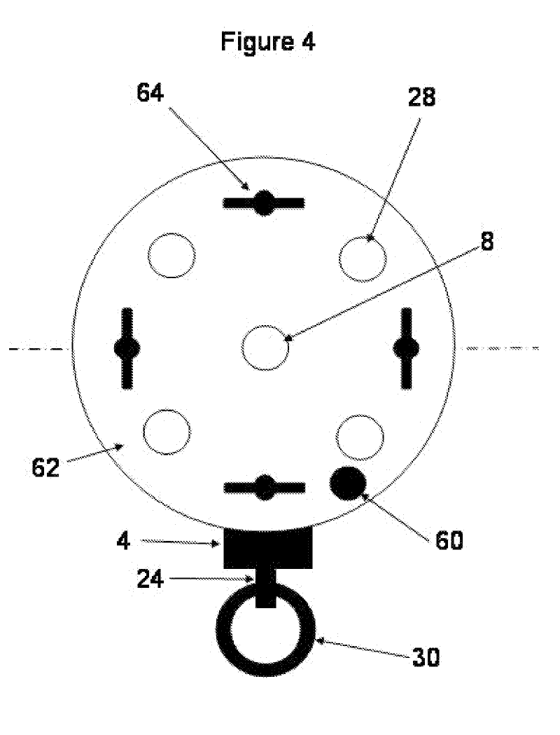

FIG. 4 shows a front view of a second embodiment of the device;

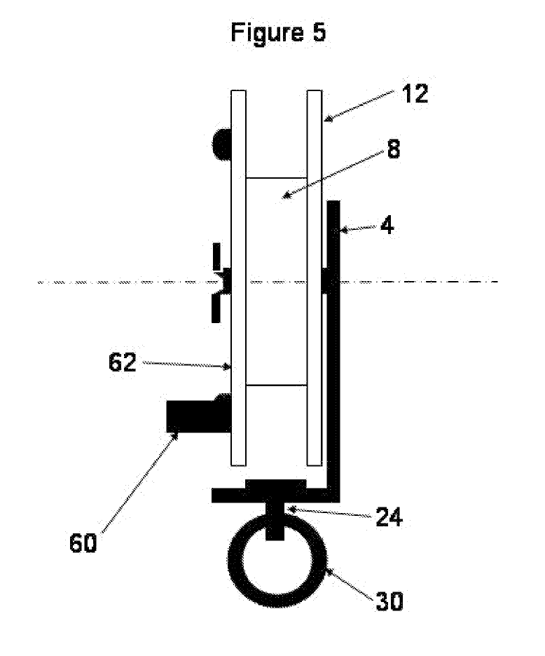

FIG. 5 shows a side view of the device of FIG. 4;

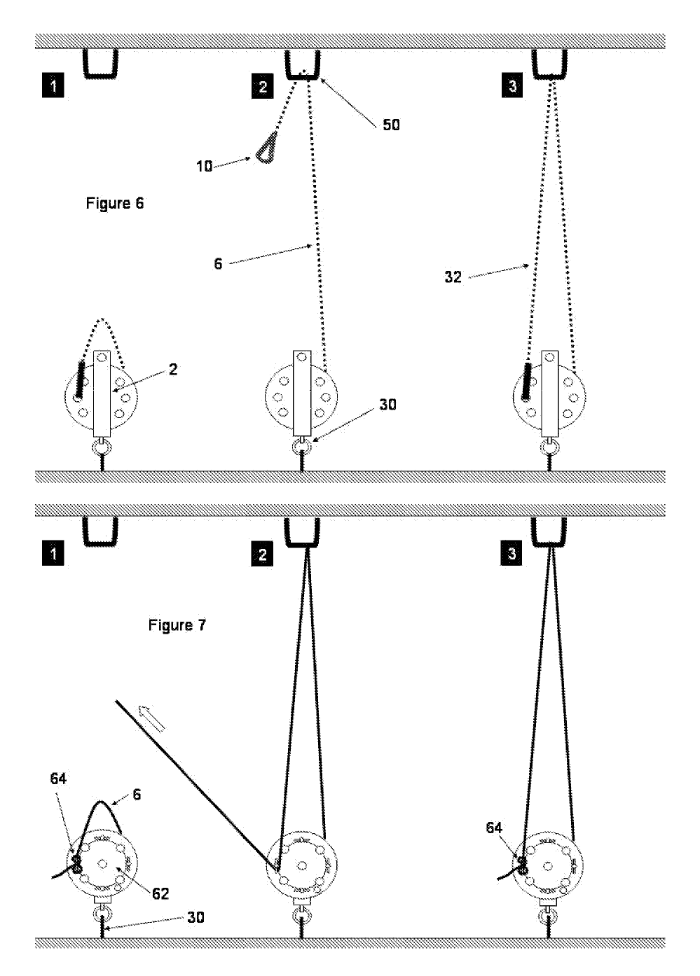

FIG. 6 shows a series of views illustrating how the device may be used in operation to link the device to an anchor point as in the mooring of a vessel; and

FIG. 7 shows a series of views illustrating a second mode of operation of the device.

Referring first to the embodiments of FIGS. 1 to 3, the device is a spool 2 or reel 2 mounted in a support frame 4 so that the spool 2 can rotate freely within the frame 4. A length of tape 6 has one end fixed permanently to a central hollow hub 8 of the spool 2. The tape 6 is wound round the hub 8 and has a clipping mechanism 10 attached at its other free end.

The spool 2 has two flanges 12 each secured to a respective end face of the hub 8 in the manner of a pulley or shuttle. These flanges 12 support the tape 6 wound on the hub 8.

The support frame 4 is U shaped and is for securing the device to a fixed object such as the ground. The support frame 4 has a back plate 14, a base 16 and a front plate 18. A spindle 20 designed to pass through a centre of the hollow hub 8 is secured to both the front and back plates. The support frame has means for securing it to a fixed object such as the ground. In this embodiment an anchor ring 30 is pivotally mounted to the base 16 by means of a rotatable shank 24. The back plate 14 is long enough to extend beyond a rim of the flange 12. A hole 26 is provided at the exposed end of the back plate.

A series of holes 28 are also provided around the periphery of at least that flange 12 of the spool 2 that sits adjacent the front plate. The holes 26, 28 are all adapted to allow the clipping mechanism 10 to be locked to them.

The clipping mechanism is ideally a locking karabiner 10 so that the tape can be hitched and unhitched to the frame 4 using only one hand.

The hub may have a conventional spring recoil mechanism 40 associated with it to wind up the tape when there is no tension on it.

In FIGS. 1 to 3 the device is shown with a fixed length of tape drawn off the spool. The clipping mechanism can also be hitched to the support. In that position the tape can be unwound from the reel. When the clipping mechanism 10 is locked to the flange, it prevents the spool rotating further to draw off any more tape from the reel.

A second embodiment is illustrated in FIGS. 4 and 5. in this embodiment of the device, the support frame 4 is single-sided. This enables a winding handle 60 to be mounted at the edge of the exposed flange 62. In this embodiment the spindle would project out of the hollow hub and is provided with locking means to prevent the reel from sliding off whilst permitting free rotation relative to the support frame 4. Four cleats 64 are positioned around the periphery of flange 62. Four holes 28 are provided between the cleats so as to provide alternative securing means for the free end of the tape 6. In this embodiment the free end may have no special clipping mechanism. The free end can be passed through a hole 28 and tied off with a knot. Alternatively the free end may be tied down to a cleat.

Reference is now made to FIG. 6 to show how the first embodiment of the device is used in the context of mooring a boat. The device is mounted to the boat by means of the anchor ring 30. When not in use as shown in the first view on the left hand side of the figure, the tape is secured so that it cannot be unwound, by the karabiner 10 fixed to the flange with only the shortest length of tape drawn off the hub in order to allow the karabiner to be clipped in position. In this storage mode no more tape can unwound and therefore tangling of the tape is prevented. In order to moor the boat to a mooring ring 30 on a pier, the karabiner is unhitched and the tape is wound out and passed through the ring 50 as shown in the second view and then returned to the device. If the karabiner 10 is secured to the back plate instead of the reel, the length of tape unwound from the reel can be adjusted until the vessel is at the required distance from the pier before the spool is locked by latching the karabiner into a hole 28 on the flange 12. As shown in the third view, the forces acting on each side of the hub are now in balance and it will not rotate further so the length of tape 32 stays of fixed length.

An alternative mode of operation of the second embodiment of the device is illustrated by the views shown in FIG. 7. In the first view, the free end of the tape is tied off to one of the cleats 64. In order to moor an object to which the support means is fixed to the mooring ring 30, the tape is passed through the ring 30 and tensioned by pulling it round a cleat as shown in the second view. The length of tape is adjusted by sliding the rope/tape through the cleat under tension e.g. as the craft is pulled towards the mooring point as is common practice. The tape is tied off to the cleat as shown in the third view to complete the mooring operation.

It will be appreciated that the mooring device would work in the same manner if the tape were passed round a bollard instead of through the ring 30.

The device can be used in many other applications. For example in tethering a light aircraft the device could be carried by the pilot and have a karabiner attached to base 16 to secure it to a ground fixing point at a landing site. Tape can then be drawn from the reel sufficient to pass over the aircraft and back to the fixing point. With the tape held taught over the aircraft the karabiner can be clipped back to a hole in the flange 12.

A tensioning device can be applied to the tape after it has been fixed to tighten the grip on the article surrounded by the tape if desired.

The device has been described by reference to tape but it will be appreciated that the tape 6 may be any form of webbing, line, rope or other material that can be wound and unwound onto the hub of the spool.

The length of tape 6 that can be fixed depends on the spacing between the holes in the flange 12. Therefore a series of holes all round the edge of the flange is desirable in order to give the user maximum flexibility and allow the fixed length to be adjusted by small increments. There could be fewer holes for a small spool or where it is acceptable for the increments between the potential fixed lengths of tape to be greater. In principle only one hole adjacent the edge of the flange is essential. In a variation the clipping mechanism could act directly on the rim of the flange without requiring a hole.

It will be appreciated that the device can also be used to suspend an article a fixed distance from the mounting of the device to a fixed object to which the support frame is secured.

The main benefits of using this device are speed, convenience and easy stowage of the tape. In agricultural applications the device would prevent the webbing getting mucky or tangled in the users limbs. The device therefore offers health and safety benefits.

What is claimed is:

1. A securing device comprising a spool having a hub and a flange secured to an end face of the hub, a support frame comprising a spindle that passes through the hub in order to allow the spool to rotate relative to the support frame; a tape having one end fixed to the hub and a free end, means for enabling a free end of the tape to be secured to the flange at a periphery thereof; and means on the support frame for securing the device to an object.

2. A device as claimed in claim 1, further comprising a clipping mechanism attached to the free end of the tape.

3. A device as claimed in claim 2, wherein the securing means comprises at least one hole in the flange for engagement with the clipping mechanism.

4. A device as claimed in claim 1, wherein the securing means comprises a hole in the periphery of the flange.

5. A device as claimed in claim 1 or 4, wherein the securing means comprises a cleat mounted on the periphery of the flange.

6. A device as claimed in claim 1, further comprising a spring recoil mechanism for winding the tape around the hub.

7. A device as claimed in claim 1, further comprising a winding handle mounted to the flange.
